(19) United States
(12) Patent Application Publication
(10) Pub. No.: US 2026/0051110 A1
(43) Pub. Date: Feb. 19, 2026

(54) CLEAR VIEW MAPPING AND REPORTING FOR VENUES

(71) Applicant: CAV HOLDINGS, LLC, Nashville, TN (US)

(72) Inventor: Matthew S. Geasey, Nashville, TN (US)

(21) Appl. No.: 19/279,747

(22) Filed: Jul. 24, 2025

Related U.S. Application Data
(60) Provisional application No. 63/682,718, filed on Aug. 13, 2024.

(51) Int. Cl. G06T 15/20; G06T 17/20; G06T 19/20

(52) U.S. Cl. CPC G06T 15/20; G06T 17/20; G06T 19/20; G06T 2200/24; G06T 2210/21; G06T 2210/56; G06T 2219/2004

(57) ABSTRACT

One embodiment provides a computer-implemented process for determining obstructed ending target objects within a venue that includes generating three-dimensional (3D) models of starting target objects, ending target objects, and obstruction objects. A 3D point cloud of a venue is generated. The venue includes the starting target objects, the ending target objects and the obstruction objects. A line trace is generated between each of the starting target objects and each of the ending target objects. Obstructed or non-obstructed results are determined based on whether each of the line traces intersect any of the obstruction objects. A user interface is visually updated by applying a first visual indicator to meshes associated with the obstructed results and a second visual indicator to meshes associated with the non-obstructed results.

### CROSS-REFERENCE TO RELATED APPLICATIONS

This application claims the priority benefit of U.S. Provisional Patent Application Ser. No. 63/682,718, filed Aug. 13, 2024, which is incorporated herein by reference in its entirety.

### COPYRIGHT DISCLAIMER

A portion of the disclosure of this patent document may contain material that is subject to copyright protection. The copyright owner has no objection to the facsimile reproduction by anyone of the patent document or the patent disclosure as it appears in the patent and trademark office patent file or records, but otherwise reserves all copyright rights whatsoever.

### TECHNICAL FIELD

One or more embodiments relate generally to venue seating, and in particular, to determine the optimal performance stage position and obstruction object positions for venue seating.

### BACKGROUND

Currently, non-obstructed, partially obstructed, or fully obstructed views for seating maps to determine line of sight for live events are determined in a two-dimensional constraint. This limitation allows for only a certain amount of accuracy for the data created. Current methods used to solve the problem of what seats are non-obstructed, partially obstructed, or fully obstructed are to use two-dimensional top view flattened computer aided design (CAD) plans of the venue, and then placing width and depth constraint data of objects to determine the obstruction, not utilizing the height constraint data.

The current process above requires a draftsperson to manually place flattened two-dimensional (2D) objects of the performance stage, obstruction objects and other objects into a CAD plan of the venue without any seating information. Once the objects are placed, the draftsperson then has to manually determine where the datum is for the line of sight location. After this determination, the next step is to have the draftsperson manually draw obstruction lines that will create a wedge shape from the datum into the seating sections of the venue around the obstruction objects placed. To fact check the above, a person must walk around each venue manually in reality after the performance stage is set up, which cannot be moved once set up due to time constraints and manpower needed.

The downfall of this process is that to determine the optimal performance stage position and obstruction object positions, the above has to be manually iterated without the use of any automation (e.g., pre-built algorithms and processes) as well as not getting to a per-seat granular level of line of sight. Without the information of seat locations, the wedge shape determining obstruction views will not be fully accurate. The inaccuracy of the process above results in incorrect seat kills, which affects the business' potential revenues. (e.g., a seat that is determined non-obstructed could be obstructed in reality or a seat that is determined obstructed could be non-obstructed in reality) and locks out many guests that would otherwise be able to attend an event.

### SUMMARY

One embodiment provides a computer-implemented method that includes a clear view process that is a three-dimensional (3D) analyzation process to determine the validity of non-obstructed, partially obstructed, or fully obstructed (types of obstructed views) views between two or more points in 3D space (e.g., indoor or outdoor venues, etc.). Some embodiments use game engine based software, 3D scanning data of a venue, and 3D models for performance objects and obstruction objects. By utilizing all three (width, depth, height) constraints of a venue and objects, this allows for real fluctuation of true obstructed views for live events to be determined. This process is needed to provide a better understanding of what is correct in reality with the use of correctly measured data points, to help reduce the use of incorrect data. In one or more embodiments, once the data is created, it is sent to a cell based cloud environment process that can then process and distill the information to usable on-sale map data.

Some embodiments provide a computer-implemented process for determining one or more obstructed ending target objects within a venue that includes generating 3D models of one or more starting target objects, one or more ending target objects, and one or more obstruction objects. A 3D point cloud of a venue is generated. The venue includes the one or more starting target objects, the one or more ending target objects and the one or more obstruction objects. A line trace is generated between each of the one or more starting target objects and each of the one or more ending target objects. Obstructed or non-obstructed results are determined based on whether each of the line traces intersect any of the one or more obstruction objects. A user interface is visually updated by applying a first visual indicator to meshes associated with the obstructed results and a second visual indicator to meshes associated with the non-obstructed results.

One or more embodiments provide a non-transitory processor-readable medium that includes a program that when executed by a processor provides determining one or more obstructed ending target objects within a venue. The program including generating, by the processor, 3D models of one or more starting target objects, one or more ending target objects, and one or more obstruction objects. The processor generates a 3D point cloud of a venue. The venue includes the one or more starting target objects, the one or more ending target objects and the one or more obstruction objects. The processor generates a line trace between each of the one or more starting target objects and each of the one or more ending target objects. The processor, determines obstructed or non-obstructed results based on whether each of the line traces intersect any of the one or more obstruction objects. The processor visually updates a user interface by applying a first visual indicator to meshes associated with the obstructed results and a second visual indicator to meshes associated with the non-obstructed results.

Some embodiments provide an apparatus including a memory storing instructions, and at least one processor that executes the instructions including a process configured to generate 3D models of one or more starting target objects, one or more ending target objects, and one or more obstruction objects. The process generates a 3D point cloud of a venue, the venue including the one or more starting target objects, the one or more ending target objects and the one or more obstruction objects. The process further generates a line trace between each of the one or more starting target objects and each of the one or more ending target objects. The process also determines obstructed or non-obstructed results based on whether each of the line traces intersect any of the one or more obstruction objects. The process further visually updates a user interface by applying a first visual indicator to meshes associated with the obstructed results and a second visual indicator to meshes associated with the non-obstructed results.

These and other features, aspects and advantages of the one or more embodiments will become understood with reference to the following description, appended claims and accompanying figures.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 is an isometric view of an example starting target object with three unique dimensions whose shape can differ at any time;

FIG. 2 is an isometric view of an ending target object with three unique dimensions whose shape can differ at any time and that utilizes a bounding box for constraints of line-of-sight (LOS) calculations, according to some embodiments;

FIG. 3 is an isometric view of an obstruction object with three unique dimensions whose shape can differ at any time;

FIG. 4 illustrates an example of a point cloud 3D representation used by the disclosed technology, according to some embodiments;

FIG. 5 is an isometric view of a venue object, according to some embodiments;

FIG. 6 is an isometric view of the combined obstruction objects and venue objects used by the disclosed technology, according to some embodiments;

FIG. 7 is an isometric view of the combined obstruction objects, venue objects and ending target objects, used by the disclosed technology, according to some embodiments;

FIG. 8 is an isometric view of the combined obstruction objects, venue objects, ending target objects and starting target objects, used by the disclosed technology, according to some embodiments;

FIG. 9 is an isometric view of a line trace function being performed between an ending target and numerous starting targets, used by the disclosed technology, according to some embodiments;

FIG. 10 is an example of data being created based on information derived from the hit results per object as shown in FIG. 9 and used by the disclosed technology, according to some embodiments;

FIG. 11 illustrates a clear view process of the disclosed technology, according to some embodiments;

FIG. 12 illustrates an example user interface used by the disclosed technology, according to some embodiments; and

FIG. 13 illustrates a high-level block diagram showing an information processing system comprising a computer system useful for implementing one or more disclosed embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

A description of example embodiments is provided on the following pages. The text and figures are provided solely as examples to aid the reader in understanding the disclosed technology. They are not intended and are not to be construed as limiting the scope of this disclosed technology in any manner. Although certain embodiments and examples have been provided, it will be apparent to those skilled in the art based on the disclosures herein that changes in the embodiments and examples shown may be made without departing from the scope of this disclosed technology.

One or more embodiments relate generally to venue seating, and in particular, to determine the optimal performance stage position and obstruction object positions for venue seating. One embodiment provides a computer-implemented method that includes processing as described below.

Some embodiments provide a computer-implemented process for determining one or more obstructed ending target objects within a venue that includes generating 3D models of one or more starting target objects, one or more ending target objects, and one or more obstruction objects. A 3D point cloud of a venue is generated. The venue includes the one or more starting target objects, the one or more ending target objects and the one or more obstruction objects. A line trace is generated between each of the one or more starting target objects and each of the one or more ending target objects. Obstructed or non-obstructed results are determined based on whether each of the line traces intersect any of the one or more obstruction objects. A user interface is visually updated by applying a first visual indicator to meshes associated with the obstructed results and a second visual indicator to meshes associated with the non-obstructed results.

One or more embodiments provide a non-transitory processor-readable medium that includes program objects. The processor generates a 3D point cloud of a venue. The venue includes the one or more starting target objects, the one or more ending target objects and the one or more obstruction objects. The processor generates a line trace between each of the one or more starting targets that when executed by a processor provides determining one or more obstructed ending target objects within a venue. The program including generating, by the processor, 3D models of one or more starting target objects, one or more ending target objects, and one or more obstruction objects and each of the one or more ending target objects. The processor determines obstructed or non-obstructed results based on whether each of the line traces intersect any of the one or more obstruction objects. The processor visually updates a user interface by applying a first visual indicator to meshes associated with the obstructed results and a second visual indicator to meshes associated with the non-obstructed results.

Some embodiments provide an apparatus including a memory storing instructions, and at least one processor that executes the instructions including a process configured to generate 3D models of one or more starting target objects, one or more ending target objects, and one or more obstruction objects. The process generates a 3D point cloud of a venue, the venue including the one or more starting target objects, the one or more ending target objects and the one or more obstruction objects. The process further generates a line trace between each of the one or more starting target objects and each of the one or more ending target objects. The process also determines obstructed or non-obstructed results based on whether each of the line traces intersect any of the one or more obstruction objects. The process further visually updates a user interface by applying a first visual indicator to meshes associated with the obstructed results and a second visual indicator to meshes associated with the non-obstructed results.

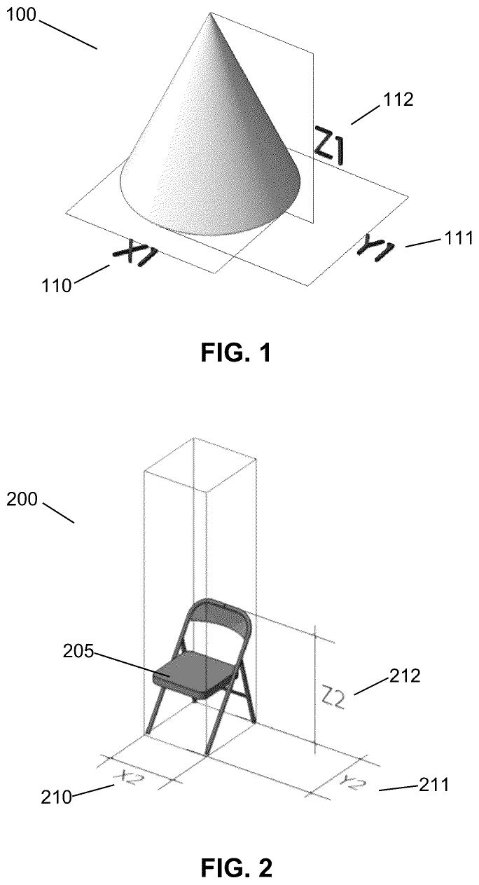

FIG. 1 is an isometric view of an example starting target object 100 with three unique dimensions (X1 110, Y1 111 and Z1 112) whose shape can differ at any time. In some embodiments, the clear view process 1100 (FIG. 11) of the disclosed technology includes an object set up process. In one or more embodiments, the clear view process 1100 may commence by generating starting target object 3D models. In some embodiments, starting target objects can be any shape desired, but they must contain a minimum of three values, X, Y, and Z, to determine the shape. There can be as many or as little amount of targets desired. In some embodiments, known technology may be used to generate the 3D models of starting target shapes.

FIG. 2 is an isometric view 200 of an ending target object 205 (with three unique dimensions (X2 210, Y2 211, Z2 212) whose shape can differ at any time and that utilizes a bounding box for constraints of line-of-sight calculations, according to some embodiments. In one or more embodiments, the clear view process 1100 (FIG. 11) generates ending target object 3D models using known technology modeling processes or applications. In some embodiments, the ending target objects (e.g., chairs, seating, tables, etc.) can be any shape desired, but they must contain a minimum of three values, X, Y, and Z to determine the shape. An ending target object can also be a 3D locus object without any 3D mesh data. The target should have a center point at which calculations can be made from in the processes described below. There can be as many or as little amount of targets desired.

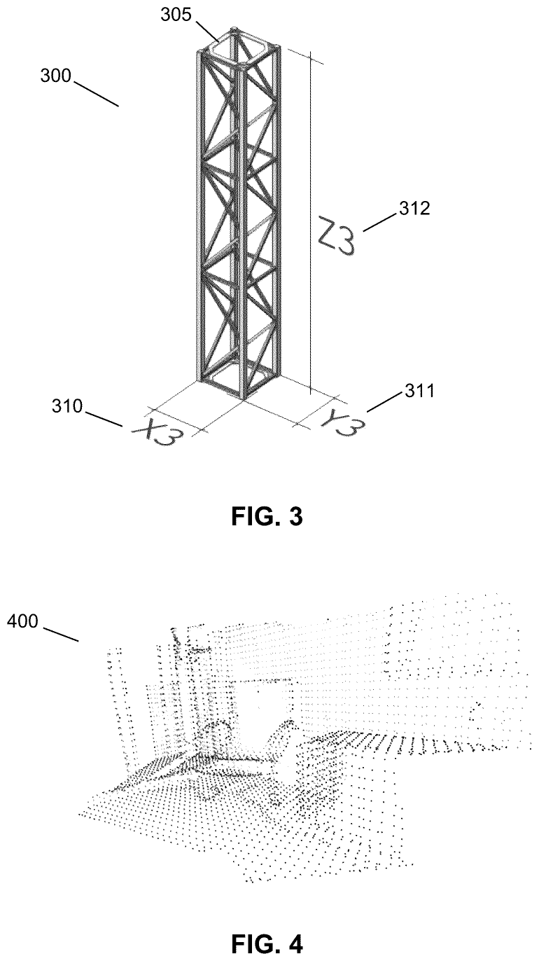

FIG. 3 is an isometric view 300 of an obstruction object 305 with three unique dimensions (X3 310, Y3 311, Z3 312) whose shape can differ at any time. In one or more embodiments, the clear view process 1100 (FIG. 11) continues with generation of obstruction object 3D models using known technology modeling processes or applications. Obstruction objects (e.g., scaffolding, trusses, sound equipment, curtains, lighting, signage, etc.) can be any shape desired, but they must contain a minimum of three values, X, Y, and Z to determine the shape. These objects must contain a collision object that is the exact shape of the object.

FIG. 4 illustrates an example of a point cloud 3D representation 400 used by the disclosed technology, according to some embodiments. A point cloud is a collection of data in a 3D coordinate system (X, Y, Z) that represents an external surface of an object or environment. Each point in a point cloud when combined form a detailed 3D “cloud.” Each contains information about its position in space. One or more embodiments employ known technology for point cloud modeling. Point clouds may be generated using technologies such as laser scanning, photogrammetry, light detection and ranging (LiDAR), structured light scanning techniques, etc. In some embodiments, drones may be employed that include LiDAR sensors. These methods involve capturing data points from various angles to build a comprehensive 3D representation.

In one or more embodiments, in the environment set up process phase (environment set up process 1130, FIG. 11) of the clear view process 1100, a point cloud of a venue is generated by scanning the venue structural object using one of the techniques indicated above, such as laser scanning, photogrammetry, a combination of the foregoing, etc. This scan must include, for example, all bleacher seating styles, skeletal structural objects, support beam objects, interior level separation objects (such as section dividers, level dividers), etc. Continuing, a 3D model of the venue is generated from a point cloud of the collection of data. By using known technology processing or applications, the clear view process 1100 takes the point cloud generated and creates the 3D mesh objects from the cloud data. In some embodiments, this phase of processing may be performed manually or by using an automated software process. The origin point of the model is created next. The origin point can be located at any location desired, and can be changed at any given time.

In some embodiments, the clear view process 1100 proceeds to generate a coordinate of the ending target object(s). From the 3D meshes that are created, the clear view process 1100 identifies the seating object meshes, which may potentially be one large mesh or individual meshes. After identifying the meshes, the clear view process 1100 breaks the meshes down into a single seating mesh object. Next, the clear view process 1100 determines the center point of each mesh object and stores that transform location (X, Y, Z) into a unique database with a universal unique identifier (UUID) or unique name for each center point.

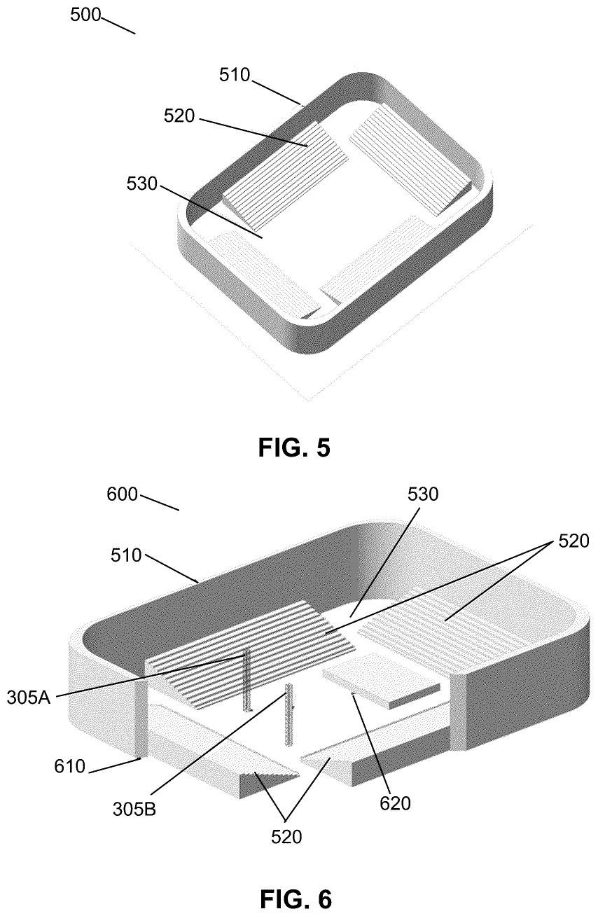

FIG. 5 is an isometric view of a venue object 500, according to some embodiments. In one or more embodiments, the venue object 500 is minimally composed of an outer shell element 510, one or more tiered seating sections 520 and a floor level 530 that defines the Z starting value.

FIG. 6 is an isometric view 600 of the combined obstruction objects 305A/305B and venue objects (outer shell element 510 (outer shell wall cut for visibility 610), one or more tiered seating sections 520, a floor level 530 and a stage 620) used by the disclosed technology, according to some embodiments. In one or more embodiments, the clear view process 1100 (FIG. 11) provides a merge process by combining one or more obstruction objects and environment meshes. In an empty environment, the clear view process 1100 takes all the objects created in the environment set up processing 1130 (FIG. 11) phase, and places them accordingly in the appropriate locations in 3D Space. All of the obstruction objects created are placed accordingly in the appropriate locations in 3D Space.

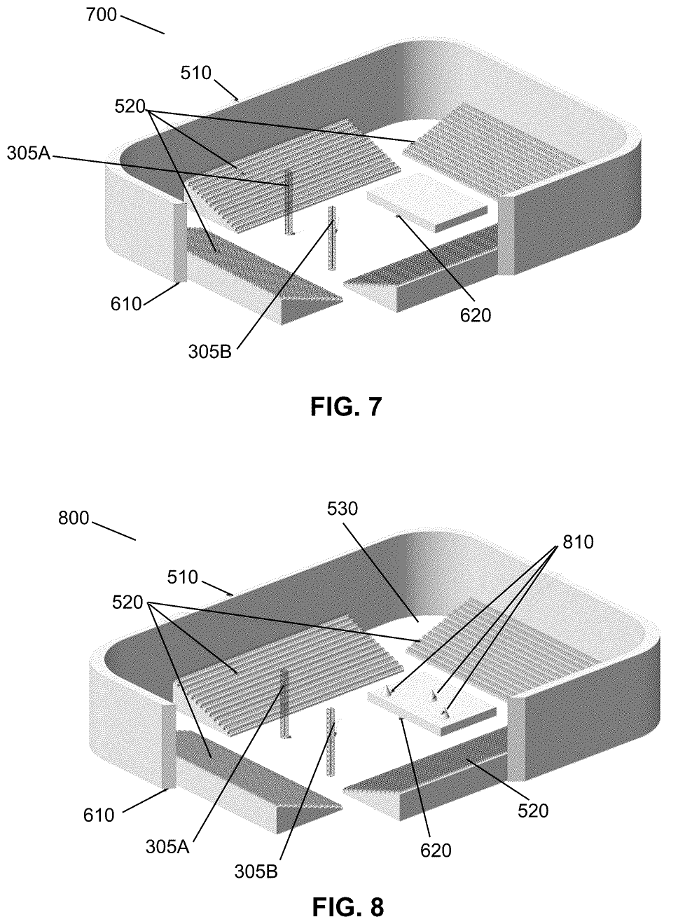

FIG. 7 is an isometric view 700 of the combined obstruction objects 305A/305B, venue objects (outer shell element 510 (outer shell wall cut for visibility 610), one or more tiered seating sections 520, a floor level 530 and a stage 620) and ending target objects (e.g., seats withing the seating sections 520), used by the disclosed technology, according to some embodiments. In one or more embodiments, the clear view process 1100 (FIG. 11) places ending targets from the coordinates stored in the database at each transform location.

FIG. 8 is an isometric view 800 of the combined obstruction objects 305A/305B, venue objects (outer shell element 510 (outer shell wall cut for visibility 610), one or more tiered seating sections 520, a floor level 530 and a stage 620), ending target objects and starting target objects 810, used by the disclosed technology, according to some embodiments. In one or more embodiments, the clear view process 1100 (FIG. 11) merges the starting targets (e.g. starting target objects 810) by using best practices to determine a performance location. The clear view process 1100 places a starting object or objects at unique transform locations and locks the transform in relation to certain obstruction objects as seen fit.

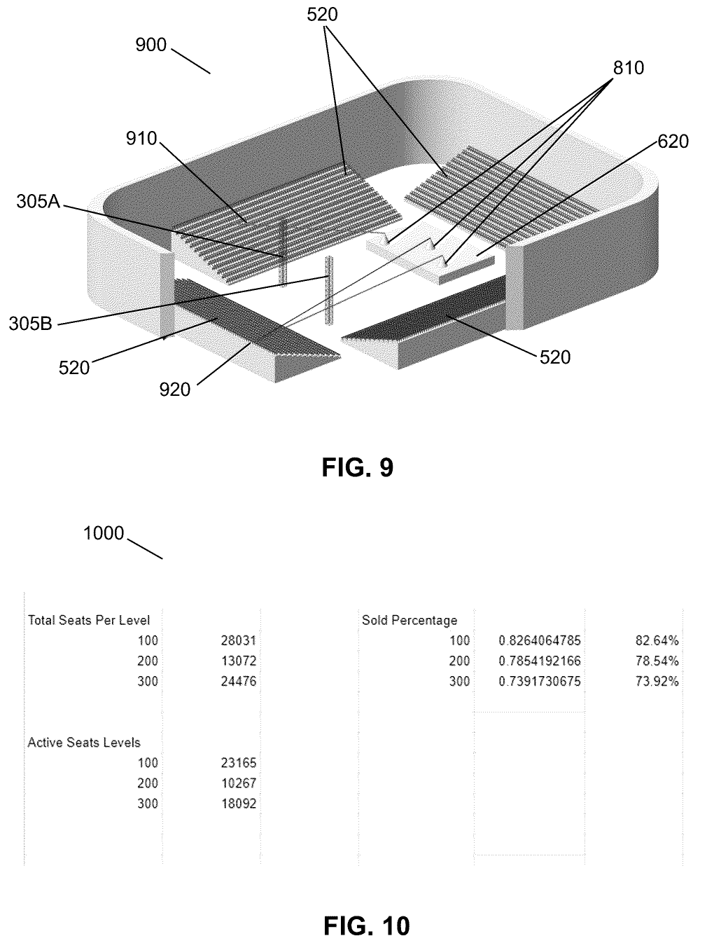

FIG. 9 is an isometric view 900 of a line trace function being performed between an ending target (end of trace lines 910/920 in the respective seating sections 520) and numerous starting targets 810, used by the disclosed technology, according to some embodiments. In this phase of the clear view process 1100 (FIG. 11), the processing commences the calculation determining phase (calculation process 1150 (FIG. 11)). In one or more embodiments, the clear view process 1100 draws a line between the starting and ending targets by utilizing known techniques, such as line tracing. In some embodiments, utilizing line tracing, the clear view process 1100 generates a line trace (e.g., trace lines 910/920) between each unique starting target and each unique ending target.

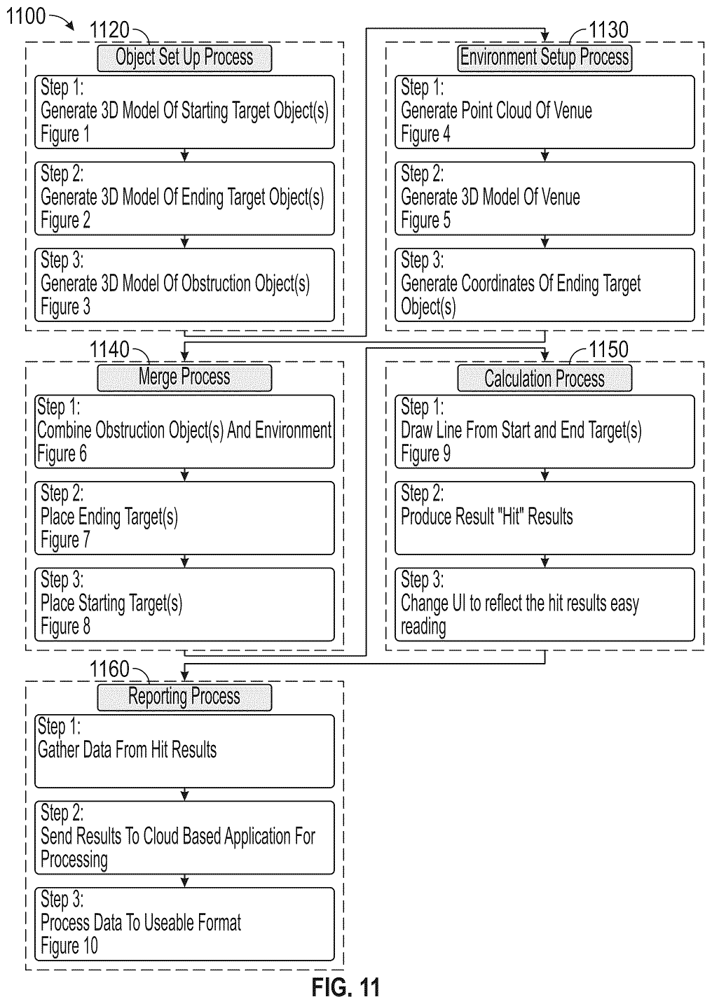

FIG. 10 is an example 1000 of data being created based on information derived from the hit results per object as shown in FIG. 9 and used by the disclosed technology, according to some embodiments. In one or more embodiments, the clear view process 1100 (FIG. 11) generates hit results by using the value of each unique line trace (e.g., trace lines 910 and 920, FIG. 9). If the line trace hits (contacts) an obstruction object, the processing returns a Boolean (or other value desired) value of false. For all values that do not return false, the processing stores those values in a unique array to be used at a later time. In one embodiment, the unique array may be referred to as a “Hit Array.” In some embodiments, for all values that return a false value, the clear view process 1100 stores those values in another unique array to be used at a later time. In one embodiment, this other array may be referred to as a “Bad Array.”

In some embodiments, the clear view process 1100 updates a user interface (UI) display by using the values from the Hit Array, and applies a unique color shader to the mesh of the ending target. Using the values from the Bad Array, the clear view process 1100 process applies another unique color shader to the mesh of the ending target. The applied colors of the color shader makes the display easy for users to distinguish blocked views and good views from a ticket holder's or visitor of the venue perspective. Therefore, the seller or provider of tickets can determine seating that can and cannot be sold due to obstructed views; or determine ticket pricing based on clear or obstructed views (i.e., some ticket buyers or visitors may still want an obstructed seat, but are less willing to pay a premium price point).

FIG. 11 illustrates a clear view process 1100 of the disclosed technology, according to some embodiments. In one or more embodiments, the clear view process 1100 utilizes known technologies for 3D modeling software applications, line tracing, game engines, and computer aided design (CAD) software in a unique way to determine seating maps for live events in venues of any size and style. The clear view process 1100 starts with the object set up process 1120 and the environment set up process 1130 building the scene or model, and then applies automated analysis methodologies in the calculation process 1150, which determines whether a seat or viewpoint is valid or invalid based on the parameters given by the end user.

In some embodiments, in the object set up process 1120 includes generating a 3D model of starting target objects (e.g., starting target object 100, FIG. 1). A 3D model of an ending target object (e.g., ending target object 205, FIG. 2) is generated. A 3D model of an obstruction object (e.g., obstruction object 305, FIG. 3) is generated. It should be noted that the 3D model generation for the starting target object, ending target object and obstruction object may be completed in any order desired.

In one or more embodiments, in the environment set up process 1130, a point cloud of the venue is generated (e.g., point cloud 3D representation 400, FIG. 4). A 3D model of the venue is generated (e.g., venue object 500, FIG. 5). Coordinates of ending object or objects are generated.

In some embodiments, merge process 1140 combines the obstruction objects and environment (e.g., isometric view 600, FIG. 6). The ending targets are placed (e.g., seats within the seating sections 520, FIG. 7). The starting targets are placed (e.g., starting target objects 810, FIG. 8).

In one or mor embodiments, in the calculation or determination process 1150, a line or vector is drawn/generated from the starting target objects and the ending target objects (e.g., trace lines 910 and 920, FIG. 9). Hit results (no obstruction views) and bad results (obstructed views) are determined and stored in a memory or memory object (e.g., a database, etc.). A UI is changed to reflect the hit results for easy reading on a display or printed report by a user (e.g., using color schemes, etc.).

In some embodiments, the clear view process 1100 includes a reporting process 1160 that gathers data from the hit results. In one or more embodiments, the reporting process 1160 gathers/obtains data from the hit results from the calculation/determination process 1150. The data from the hit results are sent or communicated to a cloud based application for processing. In other embodiments, the hit results may be used by a desktop/laptop or smart phone based application. The reporting process 1160 runs a secondary report gathering of all variable information per each unique ending target. Once the data is gathered, the data is stored in a unique “container” per defined area, which can be a section number, level number, or any other user defined unique container for the data.

In one or more embodiments, using one or more application programming interfaces (APIs), the clear view process 1100 sends the container information to an appropriate software application that is designed to manage (and track) data containers. The clear view process 1100 then processes data to place the data in a useable format for user viewing on a display (or printout). The data that is retrieved from the containers are processed using user defined criteria (or formulas) to process the data into a format that is usable for their requirements.

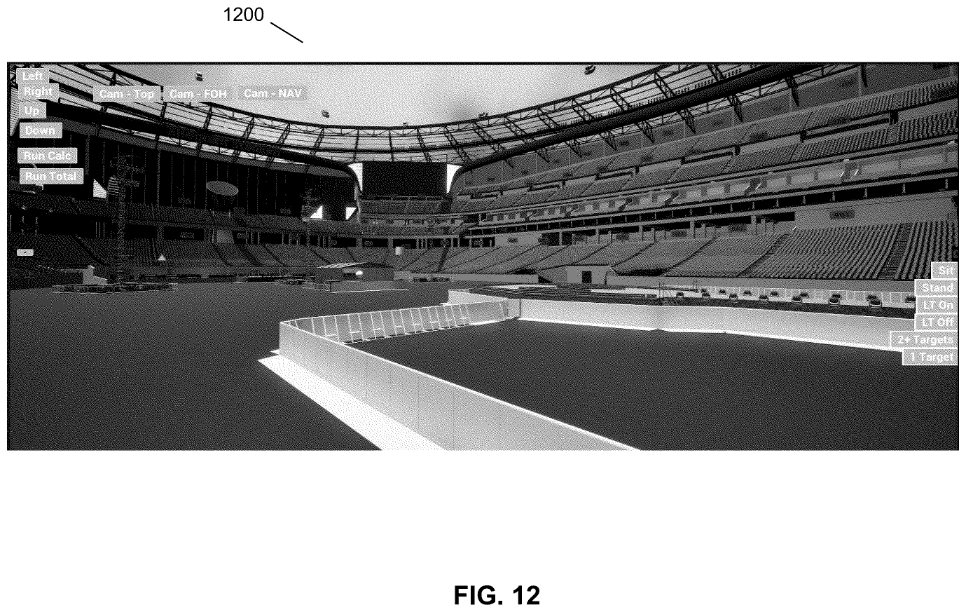

FIG. 12 illustrates an example user interface 1200 used by the disclosed technology, according to some embodiments. In a conventional process of determining seating maps from a flat two-dimensional (2D; X, Y) viewpoint, many inaccuracies are presented for informing interested ticket purchasers/attendees what seats are actually usable or not. Whilst drawing a line from point A to point B, one may be subject to the line cutting a seat in half, and it is not possible to tell if that seat is usable or not. To prevent these inaccuracies, the clear view process 1100 does not utilize any 2D viewpoints. By using a 3D viewpoint, the disclosed technology has the ability to determine an exact line-of-sight (LOS) and also adjust the third dimension (Z) if the calculation needs to be from a seated perspective or a standing perspective.

With that exact determination of a valid or invalid seat, the disclosed technology has the ability to use that information to help determine what a seat should cost, what that exact vantage point looks like utilizing 3D camera positions, how much a total section may generate revenue wise, and then determine how much the whole venue may produce revenue wise. Usable seats are one of the primary sources of revenue for live events. Every seat counts. Currently, for a typical live event, obstructed views cannot not be 100% confirmed until the show is physically set up in the venue, which either only happens the day before or the day of the live event.

Opening up seats or moving seats due to sight line issues within these time frames can cause severe potential revenue implications as normally, there are certain amounts of seats not sold to help with these moves. By creating this process, the clear view process 1100 can reduce the amount of tickets held drastically, therefore allowing higher value tickets to be sold at the front end of an on sale process, instead of waiting and potentially missing out on that revenue.

In some embodiments, the clear view process 1100, by making the functions automated, when a stage needs to be moved, or the design of the stage changes (e.g., geometry, layout, height, etc.), the disclosed technology simply drops the new model in, or moves the model in the software processing. Then the clear view processing recalculates the new location. By making this process take about an eighth of the time of the traditional process, businesses can make faster and more knowledgeable decisions about financial implications of designs of shows. In one or more embodiments, the potential for live feedback into ticketing systems for real time updating may be included in the clear view process 1100 (e.g., using machine learning modeling including artificial intelligence (AI) learning), therefore potentially reducing the amount of re-iteration of the traditional process over and over. This data gathering and reporting can be replicated by using other 3D modeling software that may not be game engine based, but with the addition of added code to process and report the data accordingly. In one example, the ending target (e.g., seating) at the end of trace lines 910/920 in the respective seating sections 520 trace lines 910 and 920 (FIG. 9) have obstructed views from the obstructions 305A and 305B. Using the clear view process 1100, the stage 620 may be moved to the left, the right, forward, back, raised, etc. by amending the stage 620 position data (e.g., manually changing coordinates, dragging a virtual stage in an application, etc.) to determine whether the obstructed view seating become clear and whether other seating becomes obstructed. This processing can also be automated to determine the maximum unobstructed views for a venue based on, for example, stage coordinates within the venue, placement of obstructions, etc.

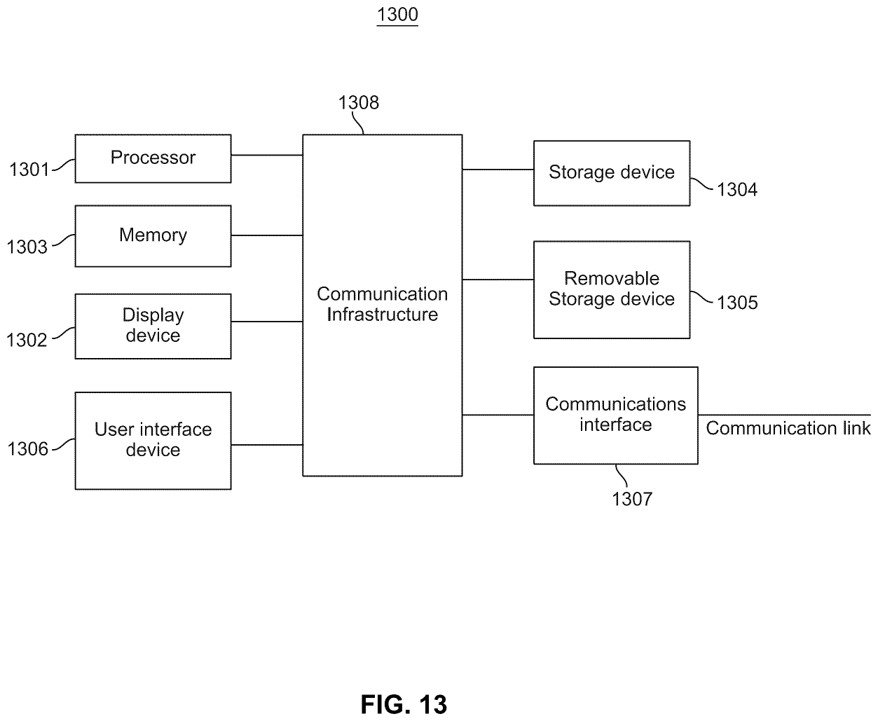

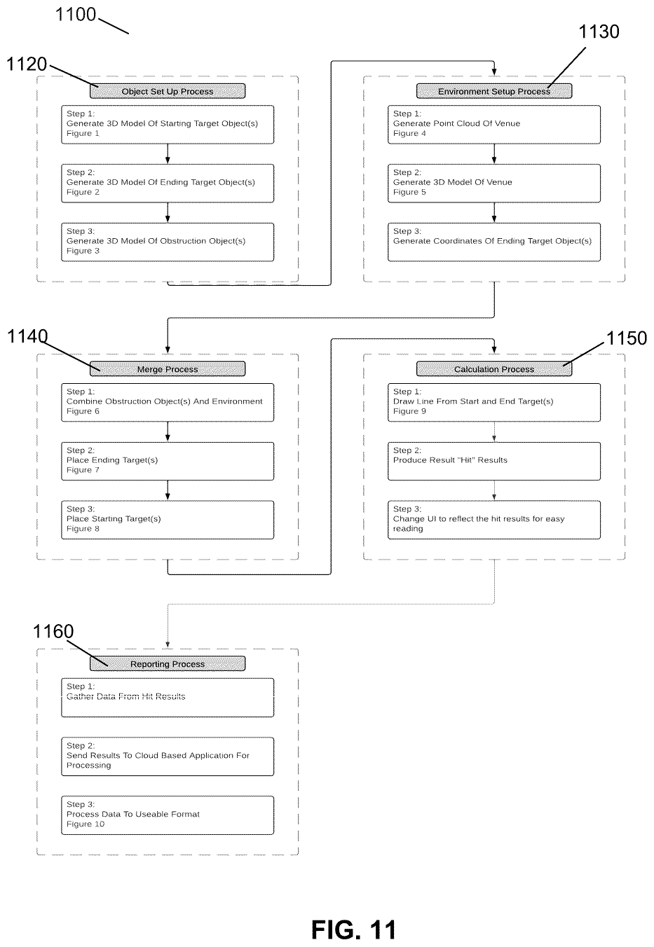

FIG. 13 illustrates a high-level block diagram showing an information processing system comprising a computer system 1300 useful for implementing one or more disclosed embodiments. Computer system 1300 may be incorporated in an electronic device, such as a desk top computer, server, tablet device, etc. The computer system 1300 includes one or more processors 1301, and can further include an electronic display device 1302 (for displaying video, graphics, text, and other data), a main memory 1303 (e.g., random access memory (RAM)), storage device 1304 (e.g., hard disk drive), removable storage device 1305 (e.g., removable storage drive, removable memory module, a magnetic tape drive, optical disk drive, computer readable medium having stored therein computer software and/or data), user interface device 1306 (e.g., keyboard, touch screen, keypad, pointing device), and a communication interface 1307 (e.g., modem, a network interface (such as an Ethernet card), a communications port, or a Personal Computer Memory Card International Association (PCMCIA) slot and card). The communication interface 1307 allows software and data to be transferred between the computer system and external devices. The system 1300 further includes a communications infrastructure 1308 (e.g., a communications bus, cross-over bar, or network) to which the aforementioned devices/modules 1301 through 1307 are connected.

Information transferred via communications interface 1307 may be in the form of signals such as electronic, electromagnetic, optical, or other signals capable of being received by communications interface 1307, via a communication link that carries signals and may be implemented using wire or cable, fiber optics, a phone line, a cellular phone link, a radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

In some embodiments, processing instructions for the clear view process 1100 (FIG. 11) may be stored as program instructions on the memory 1303, storage device 1304 and the removable storage device 1305 for execution by the processor 1301.

Embodiments have been described with reference to flowchart illustrations and/or block diagrams of methods, apparatus (systems) and computer program products. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

As will be appreciated by one skilled in the art, aspects of the embodiments may be embodied as a system, method or computer program product. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Computer program code for carrying out operations for aspects of one or more embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of one or more embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the disclosed technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the disclosed technology.

Though the embodiments have been described with reference to certain versions thereof; however, other versions are possible. Therefore, the spirit and scope of the appended claims should not be limited to the description of the preferred versions contained herein.

What is claimed is:

1. A computer-implemented process for determining one or more obstructed ending target objects within a venue, the process comprising:
generating three-dimensional (3D) models of one or more starting target objects, one or more ending target objects, and one or more obstruction objects;
generating a 3D point cloud of a venue, the venue including the one or more starting target objects, the one or more ending target objects and the one or more obstruction objects;
generating a line trace between each of the one or more starting target objects and each of the one or more ending target objects;
determining obstructed or non-obstructed results based on whether each of the line traces intersect any of the one or more obstruction objects; and
visually updating a user interface by applying a first visual indicator to meshes associated with the obstructed results and a second visual indicator to meshes associated with the non-obstructed results.

2. The process of claim 1, wherein the one or more ending target objects being defined by 3D coordinates and having a center point, the one or more starting target objects being defined by three dimensional coordinates, and the one or more obstruction objects each including a collision geometry.

3. The process of claim 1, further comprising:
converting the 3D point cloud into a 3D mesh model of the venue; and
merging the one or more starting target objects, the one or more ending target objects and the one or more obstruction objects into the 3D venue model at respective transform coordinates.

4. The process of claim 1, wherein the one or more starting target object represents a performance location within the venue and the one or more ending target objects represent a seating location within the venue.

5. The process of claim 1, further comprising automatically adjusting a position of the one or more starting target objects and re-generating the line trace between each of the one or more adjusted starting target objects and each of the one or more ending target objects for optimizing visibility across the one or more ending target objects.

6. The process of claim 5, wherein automatically adjusting the position of the one or more starting target objects comprises adjusting stage position coordinates within the venue.

7. The process of claim 5, wherein the process utilizes a 3D viewpoint of the one or more ending target objects and determines an exact line-of-sight to the one or more starting target objects, and the process adjusts a third dimension coordinate of the one or more ending target objects based on a seated perspective or a standing perspective.

8. A non-transitory processor-readable medium that includes a program that when executed by a processor provides determining one or more obstructed ending target objects within a venue, comprising:
generating, by the processor, three-dimensional (3D) models of one or more starting target objects, one or more ending target objects, and one or more obstruction objects;
generating, by the processor, a 3D point cloud of a venue, the venue including the one or more starting target objects, the one or more ending target objects and the one or more obstruction objects;
generating, by the processor, a line trace between each of the one or more starting target objects and each of the one or more ending target objects;
determining, by the processor, obstructed or non-obstructed results based on whether each of the line traces intersect any of the one or more obstruction objects; and
visually updating, by the processor, a user interface by applying a first visual indicator to meshes associated with the obstructed results and a second visual indicator to meshes associated with the non-obstructed results.

9. The non-transitory processor-readable medium of claim 8, wherein the one or more ending target objects being defined by 3D coordinates and having a center point, the one or more starting target objects being defined by 3D coordinates, and the one or more obstruction objects each including a collision geometry.

10. The non-transitory processor-readable medium of claim 8, further comprising:
converting, by the processor, the 3D point cloud into a 3D mesh model of the venue; and
merging, by the processor, the one or more starting target objects, the one or more ending target objects and the one or more obstruction objects into the 3D venue model at respective transform coordinates.

11. The non-transitory processor-readable medium of claim 8, wherein the one or more starting target object represents a performance location within the venue and the one or more ending target objects represent a seating location within the venue.

12. The non-transitory processor-readable medium of claim 8, further comprising:
automatically adjusting, by the processor, a position of the one or more starting target objects; and
re-generating, by the processor, the line trace between each of the one or more adjusted starting target objects and each of the one or more ending target objects for optimizing visibility across the one or more ending target objects.

13. The non-transitory processor-readable medium of claim 12, wherein automatically adjusting the position of the one or more starting target objects comprises adjusting stage position coordinates within the venue.

14. The non-transitory processor-readable medium of claim 12,
a 3D viewpoint of the one or more ending target objects is utilized and an exact line-of-sight to the one or more starting target objects is determined; and
a third dimension coordinate of the one or more ending target objects is adjusted based on a seated perspective or a standing perspective.

15. An apparatus comprising:
a memory storing instructions; and
at least one processor executes the instructions including a process configured to:
generate three-dimensional (3D) models of one or more starting target objects, one or more ending target objects, and one or more obstruction objects;
generate a 3D point cloud of a venue, the venue including the one or more starting target objects, the one or more ending target objects and the one or more obstruction objects;
generate a line trace between each of the one or more starting target objects and each of the one or more ending target objects;
determine obstructed or non-obstructed results based on whether each of the line traces intersect any of the one or more obstruction objects; and
visually update a user interface by applying a first visual indicator to meshes associated with the obstructed results and a second visual indicator to meshes associated with the non-obstructed results.

16. The apparatus of claim 15, wherein the one or more ending target objects being defined by 3D coordinates and having a center point, the one or more starting target objects being defined by 3D coordinates, and the one or more obstruction objects each including a collision geometry.

17. The apparatus of claim 15, wherein the process is further configured to:
convert the 3D point cloud into a 3D mesh model of the venue; and
merge the one or more starting target objects, the one or more ending target objects and the one or more obstruction objects into the 3D venue model at respective transform coordinates.

18. The apparatus of claim 15, wherein the one or more starting target object represents a performance location within the venue and the one or more ending target objects represent a seating location within the venue.

19. The apparatus of claim 15, wherein the process is further configured to:
automatically adjust a position of the one or more starting target objects; and
re-generate the line trace between each of the one or more adjusted starting target objects and each of the one or more ending target objects for optimizing visibility across the one or more ending target objects.

20. The apparatus of claim 19, wherein:
automatically adjust the position of the one or more starting target objects comprises adjusting stage position coordinates within the venue;
a 3D viewpoint of the one or more ending target objects is utilized and an exact line-of-sight to the one or more starting target objects is determined; and
a third dimension coordinate of the one or more ending target objects is adjusted based on a seated perspective or a standing perspective.
